(19) United States
(12) Patent Application Publication
(10) Pub. No.: US 2021/0354085 A1
(43) Pub. Date: Nov. 18, 2021

(54) SORPTIVE GAS SEPARATION PROCESSES EMPLOYING CHEMISORBENTS

(71) Applicant: SVANTE INC., Burnaby (CA)

(72) Inventor: Soheil KHIAVI, North Vancouver (CA)

(21) Appl. No.: 17/288,163

(22) PCT Filed: Oct. 30, 2019
(86) PCT No.: PCT/CA2019/051536

§ 371 Date: Apr. 23, 2021

Related U.S. Application Data
(60) Provisional application No. 62/752,836, filed on Oct. 30, 2018.

(51) Int. Cl. B01D 53/83; B01D 53/62; B01D 53/96; B01J 20/22; B01J 20/26; B01J 20/10

(52) U.S. Cl. CPC B01D 53/83; B01D 53/62; B01D 53/96; B01J 20/226; B01D 2258/0283; B01J 20/103; B01D 2253/20; B01D 2257/504; B01J 20/265

(57) ABSTRACT

Sorptive gas separation processes employing chemisorbents or amine doped sorbents are provided for separating a first component from a multi-component fluid mixture, or specifically for separating carbon dioxide from a combustion gas stream. The sorptive gas separation process comprises a sorbing step where during a first period of the sorbing step a first portion of a first product stream is recovered comprising a second component such as a nitrogen component, and during a second period of the sorbing step a second portion of a first product stream is recovered comprising a third component such as a water component.

### TECHNICAL FIELD

The present invention relates generally to processes for sorptive gas separation of a component from a feed stream, employing solid chemisorbents. More particularly, the present invention relates to processes for sorptive gas separation of an acid gas such as carbon dioxide from a feed stream employing amine-containing solid sorbents.

### BACKGROUND OF THE INVENTION

Sorptive gas separation processes and systems, for example, temperature swing sorption, pressure swing sorption and partial pressure swing sorption, are known in the art for use in sorptive gas separation of multi-component fluid mixtures. One type of industrial process where gas separation can be desirable includes combustion processes, for example, where an oxidant and a carbon-containing fuel are combusted generating at least heat and a combustion gas stream (also known as a combustion flue gas stream). The separation of at least one component from the combustion gas stream can be advantageous, including for example, post-combustion gas separation of carbon dioxide (CO₂).

In one aspect, an exemplary sorptive process comprising a first regenerating step, a second regenerating steps, and systems incorporating the same are disclosed in Applicant's International Published Patent Application Number WO 2017/165974 A1 titled, “ADSORPTIVE GAS SEPARATION PROCESS AND SYSTEM”.

WO 2017/165974 A1 discloses an adsorptive gas separation process employing a first regenerating step and a second regenerating step, as well as employing a first product stream as a second regeneration stream for the second regenerating step.

Chemisorbents, for example, amine doped sorbents, have demonstrated desirable characteristics, for example, high CO₂ sorption capacity and CO₂/N₂ selectivity in the presence of H₂O, for sorptive gas separation processes and systems. However, the thermal and chemical durability, for example, sorption capacity of chemisorbents decreases considerably over numerous sorption-desorption cycles. The loss in sorption capacity is typically due to, for example, undesired reaction of a chemisorbent with an adsorbate, for example, an acid gas or CO₂, induced degradation mechanisms, and/or oxidation by oxidants present in fluid streams (including, for example, oxidants present in a desorption or regeneration fluid stream). Oxidation can occur and/or increase at a higher rate when a chemisorbent is exposed to elevated temperatures, for example, at temperatures greater than about 100° C. Oxidation can also occur and/or increase at a higher rate with mild concentrations of oxygen, for example, about ambient concentrations of oxygen, and/or low humidity or dry conditions. An adsorbate or CO₂ induced degradation mechanism can occur when a chemisorbent is exposed to, for example, acid gases such as CO₂ at relatively high temperatures and dry conditions. Acid gasses or CO₂ in a fluid stream can interact with amine sites of a sorbent to form relatively strongly bonded amide functional or urea groups which can impede the release of CO₂ and deactivate the amine site during a typical regeneration process employing typical regeneration conditions and energy.

U.S. Pat. No. 9,314,730 discloses a method and system for stabilizing the performance of amine-containing CO₂ adsorbents using wet feed gas and/or wet purge gas and a method for regeneration of deactivated amine-containing CO₂ adsorbents via hydrolysis of the urea groups formed during deactivation.

For a sorptive gas separation process, chemisorbents having increased durability or designed lifespan while reducing the quantity of water sourced external to a sorptive separator and a sorptive system, which can result in reducing the complexity, capital cost and operating cost of a sorptive gas separation process and/or system, is needed.

### SUMMARY OF THE INVENTION

In various embodiments according to the present disclosure, a sorptive gas separation process for separating components of a feed stream containing at least a first component, a second component, and a third component from a feed stream is provided.

In a broad aspect of the invention, a sorptive gas separation process for separating components of a feed stream containing at least a first component, a second component and a third component comprises passing a feed stream along at least one sorbent for sorbing the first component of the feed stream onto the sorbent, producing a first portion of a first product stream, producing a second portion of the first product stream, passing a first regeneration stream along the sorbent for desorbing the first component from the sorbent, producing a second product stream containing at least the first component, recovering at least a portion of the first portion and/or the second component of the first product stream, and recovering at least a portion of the second portion, the second component, and/or the third component of the first product stream.

In another broad aspect of the invention, a sorptive gas separation process for separating components of a feed stream containing at least a first component, a second component and a third component comprises passing a feed stream along at least one sorbent for sorbing the first component of the feed stream onto the sorbent, producing a first product stream containing at least the second component and the third component, passing a first regeneration stream along the sorbent for desorbing the first component from the sorbent, and producing a second product stream containing at least the first component, wherein the third component of the first product stream is recovered from the first product stream.

In another broad aspect of the invention, a sorptive gas separation process for separating components of a feed stream containing at least a first component, a second component, and a third component comprises passing a feed stream along a sorbent for sorbing the first component of the feed stream onto the sorbent, producing a first product stream containing at least the second component and the third component, passing a first regeneration stream along the sorbent for desorbing the first component from the sorbent, and recovering the desorbed first component, wherein a ratio of a concentration or a flux of the third component in the first product stream to a concentration or a flux of the third component in the feed stream is relatively greater at a second time period than at a first time period.

### BRIEF DESCRIPTION OF THE DRAWINGS

Processes for sorptive gas separation of at least a first component from a multi-component fluid mixture according to various embodiments of the present disclosure will now be described with reference to the accompanying drawing figures, in which:

FIG. 1a is a flow diagram of an embodiment of the invention, illustrating a preliminary cycle and a steady cycle for the process for separating at least a first, second and a third component from a feed stream, and recovering at least a portion of the third component to be recirculated as part of a first regeneration stream;

FIG. 1b is a flow diagram of an embodiment of the invention, illustrating steps of a preliminary cycle for the process for separating at least a first, second and a third component from a feed stream, and recovering at least a portion of the third component to be recirculated as part of a first regeneration stream;

FIG. 2 is a graph illustrating concentrations (by volume) of carbon dioxide (CO₂), nitrogen (N₂), and water (H₂O), in a first product stream recovered from a contactor during a sorbing step of an adsorptive gas separation process employing a physiosorbent;

FIG. 3 is a graph illustrating concentrations (by volume) of carbon dioxide (CO₂), nitrogen (N₂), and water (H₂O), in a first product stream recovered from a contactor during a sorbing step of an adsorptive gas separation process employing a chemisorbent such as an amine doped sorbent;

FIG. 4 is a flow diagram of an embodiment of the invention, illustrating steps of a steady cycle for the process for separating at least a first, second and a third component from a feed stream, and recovering at least a portion of the third component to be recirculated as part of a first regeneration stream;

FIG. 5 is a flow chart in accordance to FIG. 4; and

FIG. 6 is a simplified schematic diagram illustrating a sorptive gas separation system or a sorptive separation system comprising a sorptive separator having a chemisorbent or amine doped sorbent. The sorptive gas separator is fluidly connected to receive a portion of a first product stream, as a second regeneration stream.

### DETAILED DESCRIPTION OF THE INVENTION

The term “chemisorbent” used herein is meant to include (but not limited to) an amine doped sorbent.

The term “amine doped sorbent” used herein is meant to include (but not limited to) and may be used interchangeably with, an amine grafted silica, amine impregnated mesoporous silica, an alkylated amine impregnated porous sorbent, an amine functionalized porous nano-polymers, an amine functionalized organic framework, an amine functionalized metal organic framework, an amine tethered porous polymer, and any combination thereof.

The term “feed stream” used herein is meant to include and may be used interchangeably with, a combustion gas stream, a flue gas stream, a process feed stream, a process stream, a process waste stream, an ambient air stream, and/or any combination thereof.

The term “first component” used herein is meant to include and may be used interchangeably with, an acid gas component, a carbon dioxide component, a sulfur oxide component, an oxides of nitrogen component, or a heavy metal compound.

The term “second component” used herein is meant to include and may be used interchangeably with, an inert component, a nitrogen component, or an oxygen component.

The term “third component” used herein is meant to include and may be used interchangeably with, a water component, a solvent, or a condensable fluid.

The term “flux” used herein is meant as an amount of a substance in moles or grams per unit time associated with a particular stream.

The term “preliminary cycle” used herein is meant to describe a start-up cycle comprising at least a sorbing step and a subsequent regenerating step for saturating or loading a sorbent with at least one component, in preparation for a steady cycle.

The term “steady cycle” used herein is meant to describe a process cycle comprising at least a sorbing step and a subsequent regenerating step, where the process cycle is repeated and a first product stream and/or a second product stream recovered from a sorptive separator are substantially similar in flows and compositions at any given elapsed time of the cycle. Alternatively, the integral amount of first component, second component and third component contained in first and second product stream are substantially repeated at each cycle.

The term “sorptive separator” used herein is meant to describe a device containing at least one sorbent for separating at least one component from a feed stream. A sorbent separator can comprise one or more contactors, where each contactor can comprise at least one sorbent and each sub-unit can be configured with substantially similar or different sorbents. The term “contactor” may be used herein interchangeably with the term “sorptive separator”. A sorptive process can employ at least one sorptive separator. In applications where a plurality of sorptive separators are employed, each sorptive separator can be configured with substantially similar or different sorbents and each sorptive separator can be operated at substantially similar or different process cycles.

During certain operating conditions of a sorption or sorptive process, for example, under low humidity or dry operating conditions at elevated temperatures and/or exposure to a fluid stream with elevated levels of oxygen, chemisorbents such as amine doped sorbent can experience a reduction or loss of sorption capacity or reduced durability over numerous sorption and desorption cycles, which can be a result of, for example, deactivation and/or oxidation of sorption sites. In order to reduce the deactivation of sorbent sites and increase the durability, it is advantageous to employ fluid streams which contain moisture and/or reduced levels of oxygen (for example, less than about a concentration of oxygen found in ambient air) during a sorptive process.

In some geographical locations and/or applications, a suitable supply of water may be limited and/or costly which acts as a barrier to implementation of a sorptive process having increased durability as a result of employing moisture containing fluid streams. It can be advantageous to have a sorptive process which reduces or substantially eliminates an amount of water sourced externally to a sorptive gas separation process and/or a sorptive gas separator which results in beneficially reducing the complexity, capital cost and operating cost of the sorptive gas separation process and/or sorptive gas separator.

A sorptive gas separation process (herein referred to as a “sorptive process”) is provided in accordance with an embodiment of the present disclosure, for sorptive gas separation of a multi-component fluid mixture or feed stream comprising at least a first component (for example, an acid gas component, a carbon dioxide component, a sulfur oxide component, an oxides of nitrogen component, or a heavy metal compound), a second component (for example, an inert component, a nitrogen component, or an oxygen component), and a third component (for example, a water component, a solvent, or a condensable fluid). In an embodiment, the sorptive process can desirably separate at least a portion of the first component from the multi-component fluid mixture or feed stream, which can comprise, for example, a combustion gas stream or flue gas stream (herein referred to as “combustion gas stream”) produced by a fuel combustor, a process feed stream, a process stream, a process waste stream, an ambient air stream, and/or any combination thereof, such as by employing a sorptive gas separator (herein referred as “sorptive separator”) comprising at least one contactor having at least one sorbent affixed thereto, according to an embodiment of the present disclosure. In one aspect, the sorptive process can be particularly suitable for gas separation applications where a sorptive separator and/or at least one contactor; employs at least one sorbent such as a chemisorbent, for example, an amine doped sorbent including but not limited to, an amine grafted silica, amine impregnated mesoporous silica, an alkylated amine impregnated porous sorbent, an amine functionalized porous nano-polymers, an amine functionalized organic framework, an amine functionalized metal organic framework, an amine tethered porous polymer, and any combination thereof; employs at least one fluid stream containing moisture for the sorptive process; and reduces or substantially eliminates an amount of water sourced external to the sorptive process and/or sorptive separator. In an embodiment, the sorptive process is particularly suitable for a temperature swing processes, a partial pressure swing processes, a humidity swing process, a pressure swing process, a vacuum swing process, and/or any combination thereof. In another embodiment, the chemisorbent or amine doped sorbent can be a solid sorbent. In one embodiment, the sorptive process can comprise a plurality of steps, where the process steps are cyclically repeated over numerous cycles. In another embodiment, the sorptive process can comprise at least one preliminary cycle preceding a steady cycle, where the at least one preliminary cycle can be employed in order to enable and/or achieve the stead cycle which can optionally be cycled substantially continuously as desired.

In an embodiment, a sorptive process comprise at least one preliminary cycle where the at least one preliminary cycle can be employed to substantially saturate or load a sorbent, for example, a chemisorbent or amine doped sorbent, with one or more components including, for example, a first component such as an acid gas component, a sulfur oxide component, an oxides of nitrogen component, a carbon dioxide (herein referred to as “CO₂”) component or a heavy metal compound, and/or a third component such as water, a solvent or a condensable gas), enable, and/or achieve a steady cycle which can then be cycled and operated substantially continuously. In one embodiment, a sorptive process comprise repeating at least one preliminary cycle until breakthrough of a third component in a first product stream forming and/or producing a part of the first product stream; until the first product stream comprises a third component and/or the first product stream reaches or achieves a quantity equal to or above a predetermined threshold of the third component. In one embodiment, a sorptive process comprise repeating at least one preliminary cycle until breakthrough of a first component in a second product stream forming and/or producing a part of the second product stream; until the second product stream comprises a first component and/or the second product stream reaches or achieves a quantity equal to or above a predetermined threshold of the first component.

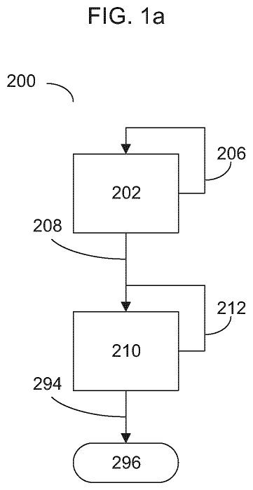

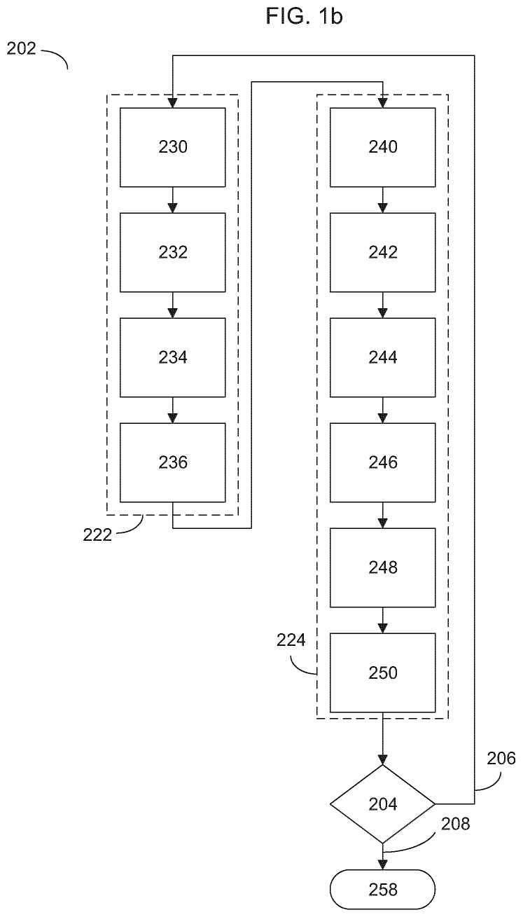

FIG. 1a is a flow diagram of an embodiment of the invention, illustrating a preliminary cycle 202 and a steady cycle 210 for a sorptive process 200. At least one preliminary cycle 202 can be employed to substantially saturate or load a sorbent with one or more components, where after one or more preliminary cycle 202, a measurement of a product stream can be taken to determine if the sorbet is loaded or unloaded. If the sorbent is unloaded, a repeating preliminary cycle 206, can result in initiating and repeating of preliminary cycle 202. If the sorbent is loaded, a terminating preliminary cycle 208, can result in terminating of preliminary cycle 202, and/or steady cycle 210, which can be repeated as desired with a repeating steady cycle 212 or can be terminated with a terminating steady cycle 294 and an end 296.

FIG. 1b is a flow diagram of an embodiment of the invention, illustrating steps of a preliminary cycle for the sorptive process. In an embodiment, a preliminary cycle 202, comprises a sorbing step 222, and at least one regenerating step 224. In one embodiment, sorbing step 222 further comprises: an optional admitting 230, for admitting and/or passing a feed stream into a contactor; a passing 232, for passing the feed stream along at least one sorbent (for example, a chemisorbent or amine doped sorbent); a sorbing and producing 234, for sorbing a first component (for example, an acid gas component, a sulfur oxide component, an oxides of nitrogen component, a CO₂ component, or a heavy metal compound), and a third component (for example, water, a solvent, or a condensable fluid), of the feed stream on and/or in the at least one sorbent, and producing a first product stream, comprising a second component, for example, an inert component, a nitrogen (herein referred to as “N₂”) component, or an oxygen component, and optionally depleted in the third component relative to the feed stream; and a recovering 236, for recovering and/or exhausting the first product stream optionally from the contactor. In one embodiment, regenerating step 224, further comprises: an optional admitting 240, for admitting a regeneration stream (for example, a first regeneration stream) such as a fluid stream comprising a third component, into a contactor; a passing 242, for passing the regeneration stream along the at least one sorbent; a sorbing 244, for sorbing at least a portion of the third component of the regeneration stream onto the at least one sorbent; a desorbing 246, for desorbing at least a portion of the first component sorbed on the sorbent; a producing 248, for producing a second product stream comprising at least the first component; and a recovering 250 for recovering the first component and/or second product stream optionally from the contactor. After recovering 250 and/or regenerating step 224, a decision 204 can be made, for example, sorbent loaded or sorbent unloaded. If decision 204 results in a sorbent unloaded and a repeating preliminary cycle 206, preliminary cycle 202 can be repeated. If decision 204 results in a sorbent saturated or loaded and a terminating preliminary cycle 208, preliminary cycle 202 can result in optionally an end 258, subsequently followed by a steady cycle (not shown in FIG. 1b) of a sorption or sorptive process. In further embodiments, preliminary cycle 202 comprises (subsequent to regenerating step 224 and prior to decision 204) an optional second regeneration step (not shown in FIG. 1b) and/or an optional cooling step (not shown in FIG. 1b).

In one embodiment, a sorbing step and subsequent at least one regenerating step of a preliminary cycle can be repeated such that during a sorbing step and at least one regenerating step, the third component (contained in the feed stream and/or the regeneration stream) is sorbed onto at least one sorbent until the sorbent is loaded with the third component. In one aspect of a sorptive process employing sorbents, such as chemisorbents or amine doped sorbents, during a preliminary cycle and/or a steady cycle, a third component may be sorbed onto the sorbent and conveyed from, for example, a sorbing step to a regenerating step, and/or a regenerating step to a sorbing step.

In one embodiment, a contactor having at least one sorbent affixed thereon and/or the at least one sorbent can be deemed unloaded when a first product stream, for example, produced during a sorbing step, is depleted in the third component relative to the feed stream, and/or comprise a concentration or a flux of the third component less than a flux of the third component in the feed stream.

In another embodiment, the contactor and/or the at least one sorbent can be deemed loaded when a first product stream produced during a sorbing step, is enriched in the third component relative to the feed stream, and/or comprise a flux of the third component greater than a flux of the third component in the feed stream, which can be achieved during a sorbing step when the first component of a feed stream sorbs onto the at least one sorbent, and assists in desorbing any third component (sorbed on the at least one sorbent) which can form at least a portion of the first product stream.

In another embodiment, a contactor and/or at least one sorbent can be deemed loaded when a second product stream produced during a regenerating step (or a first regenerating step), is enriched in the first component relative to the feed stream, and/or comprise a concentration or flux of the first component greater than a concentration or flux of the first component in the feed stream, which can be achieved during a regenerating step when the third component of a first regeneration stream sorbs onto the at least one sorbent and assists in desorbing any first component (sorbed on the at least one sorbent) which can form at least a portion of a second product stream. In another embodiment, a preliminary cycle may be complete and terminated, and/or a subsequent steady cycle initiated, when breakthrough of a third component in a first product stream and/or a first component in a second product stream, from a contactor or an end of a contactor occurs or is detected, when the first product stream comprise the third component, and/or when the second product stream comprise the first component.

Typically, a feed stream for a sorption or sorptive process can be a multi-component fluid mixture having a plurality of components where each individual component can have a different affinity for a sorbent employed in a contactor. In an embodiment, a sorptive process can include gas separation of a first component, a second component or inert component, and a third component. In an embodiment, the first component can comprise an acid gas component, a sulfur oxide component, an oxides of nitrogen component, a CO₂ component, or a heavy metal compound; the second component can comprise a nitrogen (hereinafter referred to as “N₂”) component, and the third component can comprise a water (hereinafter referred to as “H₂O”) component.

In a typical sorption or sorptive gas separation process known in the art, conventional physiosorbents for example, zeolites and activated carbons, can be employed where the first or CO₂ component can have a relatively median or average affinity (relative to other components in the feed or combustion gas stream) for the adsorbent, the second or N₂ component can have a relatively weak affinity for the adsorbent, while the third or H₂O component can have a relatively strong affinity for the adsorbent.

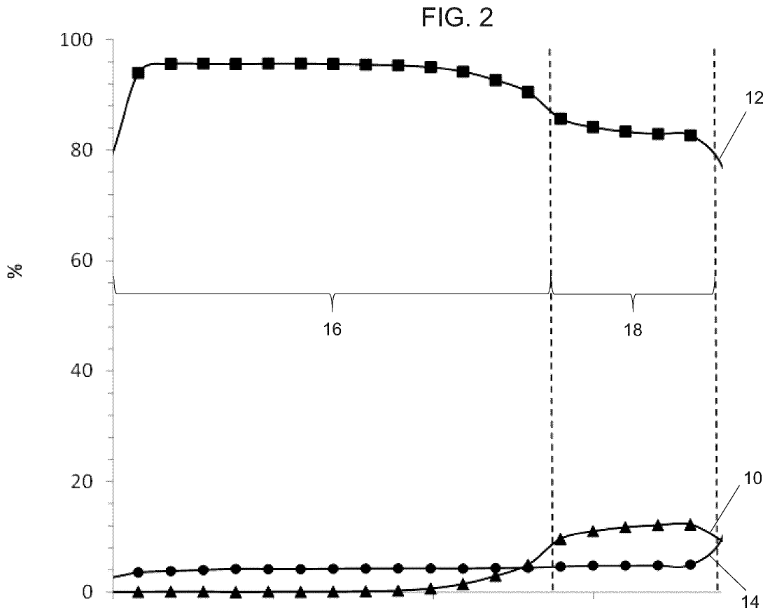

FIG. 2 is a graphical illustration of data results generated by the inventors, from testing a typical, known sorptive gas separation process employing physiosorbents, operating at substantially about a steady cycle (after operating at preliminary cycles). The y-axis represents volume concentration in percentage and the x-axis represents time in seconds. A fluid stream simulating a typical combustion gas stream was employed as a feed stream for a contactor, while a mass spectrometer was employed to measure the first product stream produced and recovered from the contactor. Sensors for the mass spectrometer were located near the outlet of the contactor. Additional tests were conducted employing a combustion gas stream as a feed stream, showing similar results. FIG. 2 shows the volume concentration of a first component or CO₂ (plot 10), a second component or N₂ (plot 12), and a third component or H₂O (plot 14), of a first product stream recovered from a contactor, having at least one physiosorbent affixed thereon, during a sorbing step of a sorptive process. A first period 16, can be representative of the sorbing step as the second component or N₂ passes through the contactor and/or prior to breakthrough of first component or CO₂ from an end or outlet of the contactor, while a second period 18, can be representative of the sorbing step after breakthrough of CO₂. A first portion of a first product stream produced during first period 16, a concentration of the first component or CO₂ (plot 10) in the first portion of the first product stream is less than a concentration of first component or CO₂ in the feed stream, a concentration of the second component or N₂ (plot 12) in the first portion of the first product stream is greater than a concentration of the second component or N₂ in the feed stream, while a concentration of the third component or H₂O (plot 14) in the first portion of the first product stream is substantially similar to a concentration of the third component or H₂O in the feed stream. A second portion of the first product stream produced during second period 18, a concentration of the first component or CO₂ (plot 10) in the second portion of the first product stream approaches a substantially similar concentration of first component or CO₂ in the feed stream, a concentration of the second component or N₂ (plot 12) in the second portion of the first product stream approaches a substantially similar concentration of the second component or N₂ in the feed stream, while a concentration of the third component or H₂O (plot 14) in the second portion of the first product stream is substantially similar to a concentration of the third component or H₂O in the feed stream. The concentration of the third component or H₂O (plot 14) in the first product stream remains substantially unchanged in the first portion of the first product stream produced during first period 16 and in the second portion of the first product stream produced during second period 18. A ratio of a concentration of the second component in the first product stream to a concentration of the second component in the feed stream is relatively greater in the first portion of the first product stream produced during first period 16 than the second portion of the first product stream produced during second period 18. A ratio of a concentration of the third component in the first product stream to a concentration of the third component in the feed stream is relatively substantially same or substantially similar in the first portion of the first product stream produced during first period 16 and in the second portion of the first product stream produced during the second period 18. This lack of differentiation highlights the disadvantage of the existing sorptive processes.

In contradiction to physiosorbents, in an embodiment of the present invention, chemisorbents such as amine doped sorbent can be employed in such a manner where the first component (for example, CO₂) component can have a relatively strong affinity for the sorbent, the third component (for example, H₂O component) can have a relatively strong affinity for the sorbent, and the first and third components can have a relatively enhanced co-sorptive affinity (relative to other components in the feed or combustion gas stream) for the sorbent, while the second component (for example, N₂) component can have a relatively weak affinity for the sorbent, such that the first and third components have an affinity in a same order of magnitude for the sorbents.

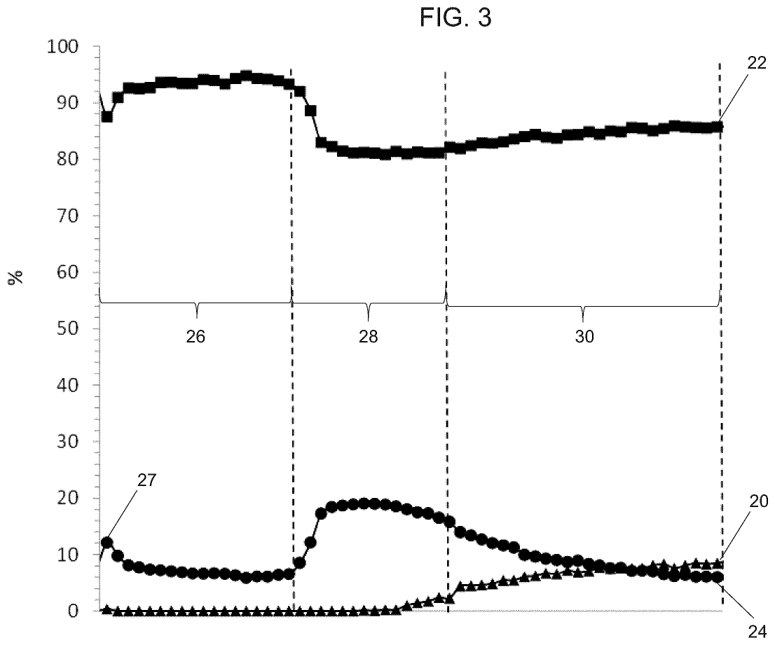

FIG. 3 is a graphical illustration of an embodiment of the present invention using a chemisorbent, such as an amine doped sorbent. The y-axis represents volume concentration in percentage and the x-axis represents time in seconds. FIG. 3 shows data results generated by the inventors testing an embodiment sorption or sorptive process, particularly a sorptive step of a sorptive gas separation process operating at substantially about a cyclic steady cycle (after operating at preliminary cycles). A fluid stream simulating a typical combustion gas stream was employed as a feed stream for a contactor, while a mass spectrometer was employed to measure the first product stream produced and recovered from the contactor. Sensors for the mass spectrometer were located near the outlet of the contactor. Additional tests were conducted employing a combustion gas stream as a feed stream, showing similar results. FIG. 3 shows the volume concentration of, a first component or CO₂ (plot 20), a second component or N₂ (plot 22), and a third component or H₂O (plot 24), of a first product stream recovered from a contactor. As shown, a first period 26, is representative of a sorbing step as the second component passes through the contactor and/or prior to breakthrough of third component (such as H₂O) and first component (such as CO₂), while a second period 28, is representative of the sorbing step during breakthrough of third component (and prior to breakthrough of first component), and a third period 30 is representative of the sorbing step during breakthrough of first component. A first portion of the first product stream produced during first period 26, a concentration of the first component or CO₂ (plot 20) in the first portion of the first product stream is less than a concentration of first component or CO₂ in the feed stream, a concentration of the second component or N₂ (plot 22) in the first portion of the first product stream is greater than a concentration of the second component or N₂ in the feed stream, while a concentration of the third component or H₂O (plot 24) in the first portion of the first product stream approaches substantially similar concentration of the third component or H₂O in the feed stream. Also during first period 26, point 27 on the third component or H₂O (plot 24) in the first portion of the first product stream shows a concentration of the third component which is greater than a concentration of the third component in the feed stream, which is a result of the third component sorbed onto the sorbent and conveyed from a previous regenerating step. A second portion of the first product stream produced during second period 28, a concentration of the first component or CO₂ (plot 20) in the second portion of the first product stream is less than a concentration of first component or CO₂ in the feed stream, a concentration of the second component or N₂ (plot 22) in the second portion of the first product stream approaches substantially similar concentration of the second component or N₂ in the feed stream, while a concentration of the third component or H₂O (plot 24) in the second portion of the first product stream is greater than a concentration of the third component or H₂O in the feed stream. A third portion of the first product stream produced during third period 30, a concentration of the first component or CO₂ (plot 20) in the third portion of the first product stream approaches substantially similar concentration of first component or CO₂ in the feed stream, a concentration of the second component or N₂ (plot 22) in the third portion of the first product stream approaches substantially similar concentration of the second component or N₂ in the feed stream, while a concentration of the third component or H₂O (plot 24) in the third portion of the first product stream approaches substantially similar concentration of the third component or H₂O in the feed stream. A ratio of a concentration of the second component in the first product stream to a concentration of the second component in the feed stream, is relatively greater in the first portion of the first product stream produced during first period 26 than in the second portion of the first product stream produced during second period 28. A ratio of a concentration of the third component in the first product stream to a concentration of the third component in the feed stream, is relatively greater in the second portion of the first product stream produced during second period 28 than in the first portion of the first product stream produced during first period 26. The concentration profile of the third component or H₂O (plot 24) in the first product stream, particularly in the second portion of the first product stream produced during second period 28 advantageously enables the recovery and employment of the third component or H₂O for a sorptive process.

In a particular embodiment according to the present disclosure, a sorptive separator and/or a contactor comprise at least one sorbent such as a chemisorbent, for example, an amine doped sorbent including but not limited to, an amine grafted silica, amine impregnated mesoporous silica, an alkylated amine impregnated porous sorbent, an amine functionalized porous nano-polymers, an amine functionalized organic framework, an amine functionalized metal organic framework, an amine tethered porous polymer, and any combination thereof; and optionally an enclosure (for housing the at least one contactor). The chemisorbent or amine doped sorbent can be a solid.

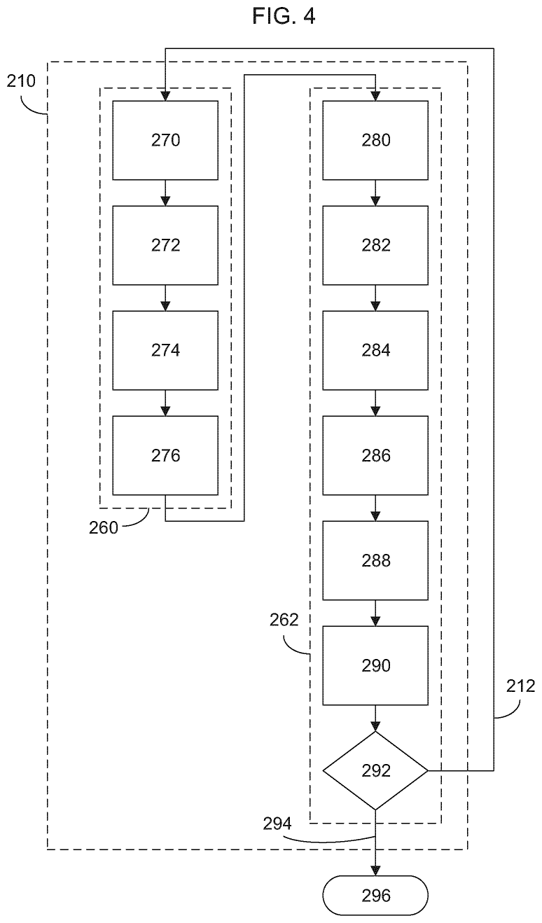

FIG. 4 is a flow diagram of an embodiment of the invention, illustrating steps of a steady cycle for a sorptive process. In a process embodiment, a sorptive process comprise at least one steady cycle 210 further comprising: at least a sorbing step 260, and at least one regenerating step 262. In one embodiment, sorbing step 260 comprises: admitting 270, for admitting a feed stream (for example, a combustion gas stream produced by a fuel combustor, a process feed stream, a process stream, a process waste stream, an ambient air stream, or any combination thereof), into a contactor; a passing 272, for passing the feed stream along at least one sorbent (for example, a chemisorbent or amine doped sorbent); a sorbing and producing 274, for sorbing a first component (for example, an acid gas, a sulfur oxide component, an oxides of nitrogen component, a CO₂ component, or a heavy metal compound), of the feed stream onto the at least one sorbent and producing a first product stream comprising a second component (for example, an inert component, a N₂ component, or an oxygen component), and a third component (for example, water, a solvent, or a condensable fluid); and a recovering 276 for recovering and exhausting the first product stream optionally from the contactor. In one embodiment, at least one regenerating step 262 comprises: admitting 280, for admitting a regeneration stream (for example, a first regeneration stream) such as a fluid stream comprising a third component and optionally a first component, into a contactor; a passing 282, for passing the regeneration stream along the at least one sorbent; a sorbing 284, for sorbing at least a portion of the third component of the regeneration stream onto the at least one sorbent; a desorbing 286, for desorbing at least a portion of the first component sorbed on the sorbent; a producing 288, for producing a second product stream comprising at least the first component; and a recovering 290, for recovering the first component and/or second product stream optionally from the contactor. After recovering 290 and/or regenerating step 262, a decision 292 can be made, for example, a repeating steady cycle 212, or a terminating steady cycle 294. An optional second regeneration step (not shown in FIG. 4) and/or an optional cooling step (not shown in FIG. 4), can be employed prior to repeating steady cycle 210 and initiating sorbing step 260. Terminating steady cycle 294 can result in an end 296. In further embodiments, steady cycle 210 comprises (subsequent to regenerating step 262 and prior to decision 294) an optional second regeneration step (not shown in FIG. 4), an optional conditioning step (not shown in FIG. 4), and/or an optional cooling step (not shown in FIG. 4). In alternative embodiments, steady cycle 210 comprises decision 292, repeating steady cycle 212, and terminating steady cycle 294.

In further embodiments, a sorptive process comprise at least one of: a ratio of a flux of a third component in a first product stream to a flux of the third component in a feed stream is relatively greater in a second portion of the first product stream produced during a second period of a sorbing step than in a first portion of the first product stream produced during a first period of a sorbing step; recovering a third component from the first product stream; recovering a third component from a second portion of a first product stream produced during a second period of a sorbing step; recirculating and/or employing at least a portion of a third component recovered from a first product stream for at least a part of a regeneration stream (such as, a first regeneration stream, and/or a second regeneration stream) contacted with the same or a different contactor operating under the same or a different steady cycle as the contactor generating the product stream.

In a process embodiment according to the present disclosure, during a steady cycle of a sorptive process, an initial or a sorbing step comprises: optionally admitting and passing a feed stream (for example, a combustion gas stream, a process feed stream, a process stream, a process waste stream, an ambient air stream, and/or any combination thereof) having a first component (such as an acid gas component, a CO₂ component, a sulfur oxide component, an oxides of nitrogen component, or a heavy metal compound), a second component (such as an inert component, a N₂ component, or an oxygen component), and a third component (such as a H₂O component, a solvent or a condensable fluid), into at least one contactor; passing the feed stream along the at least one sorbent; and sorbing at least a portion of the first component of the feed stream on at least one sorbent of at least one contactor. As the feed stream contacts the at least one sorbent such as a chemisorbent or an amine doped sorbent of at least one contactor, at least a portion of a first component (such as a CO₂ component) and optionally a third component (such as H₂O) of the feed stream can sorb (for example, absorb and/or adsorb), on the at least one sorbent, separating at least the first and optionally the third components from the remaining non-sorbed components of the feed stream.

In a particular process embodiment, a sorbing step further comprise a first period of a sorbing step (substantially concurrent with the sorbing step) where a first portion of a first product stream having a second component (such as a N₂ component) comprising a volume flux equal to or greater than, for example, about 80%, about 85%, about 90%, or about 95%, optionally depleted (relative to the feed stream) in the first component (such as a CO₂ component), can be recovered optionally from at least one contactor. In a process embodiment, a first period of a sorbing step comprises: optionally admitting a feed stream into at least one contactor comprising at least one sorbent, for example, a chemisorbent or an amine doped sorbent; passing the feed stream along the at least one sorbent; sorbing at least a portion of a first component of the feed stream on the at least one sorbent of the at least one contactor; producing a first portion of a first product stream; recovering the first portion of the first product stream optionally from the at least one contactor; optionally further separating and recovering a second component (such as a N₂ component) from the first portion of the first product stream; and recovering or exhausting the first portion of the first product stream. In an embodiment, a sorptive process can comprise employing (and admitting into at least one contactor) at least a portion of a first portion of the first product stream and/or a second component (such as a N₂ component) recovered from a first portion of a first product stream, as at least one of: a portion of a feed stream during a sorbing step; at least a portion of a regeneration stream during a regenerating step; at least a portion of a first regeneration stream during a first regenerating step, and/or at least a portion of an optional second regeneration stream during an optional second regenerating step. In one embodiment, at least a portion of a first portion of the first product stream recovered optionally from at least one contactor can be admitted into a downstream gas processing device prior to venting into the atmosphere. In one aspect, a first period of a sorbing step, producing a first portion of a first product stream, and/or recovering of the first portion of the first product stream can be completed and terminated when a pre-determined value has been achieved, for example, when a predetermined sorption time has elapsed, and/or when a predetermined flux of at least one of a second component or a third component is achieved in the first portion of the first product stream. Upon completion and/or termination of a first period of a sorbing step and/or recovery of a first portion of a first product stream, in one aspect, a subsequent second period of a sorbing step and recovery of a second portion of a first product stream can follow the first period of the sorbing step.

In a process embodiment, a sorbing step can further comprise a second period of a sorbing step (substantially concurrent with the sorbing step) where a second portion of a first product stream having a third component (such as a H₂O component) concentration or flux equal to or greater than, for example, about a concentration or flux of a first component, optionally depleted (relative to the feed stream) in the first component (such as a CO₂ component), can be recovered optionally from at least one contactor. In an embodiment comprising a feed stream having, for example, moisture or a combustion gas stream, a sorbing step can further comprise a second period of a sorbing step (substantially concurrent with the sorbing step), where a second portion of a first product stream having a third component (such as a H₂O component) comprising a volume concentration equal to or greater than, for example, about 2%, about 4%, about 6%, about 8%, or about 10%, optionally depleted (relative to the feed stream) in the first component (such as a CO₂ component), can be recovered and/or exhausted optionally from at least one contactor. In an embodiment, a second period of a sorbing step comprises: optionally admitting a feed stream into the at least one contactor comprising at least one sorbent, for example, a chemisorbent and/or an amine doped sorbent; passing the feed stream along the at least one sorbent; sorbing at least a portion of a first component of the feed stream on the at least one sorbent of the at least one contactor; producing a second portion of a first product stream; recovering the second portion of the first product stream optionally from the at least one contactor; optionally further separating and recovering at least one of a second component (such as a N₂ component), and/or a third component (such as a H₂O component) from the second portion of the first product stream; and optionally recovering or exhausting the first product stream. In one embodiment, a ratio of a concentration or flux of the second component in the first product stream to a concentration or flux of the second component in the feed stream, is relatively greater in a first portion of a first product stream produced during a first period of the sorbing step than in a second portion of the first product stream produced during a second period of the sorbing step; and/or a ratio of a flux of the third component in the first product stream to a flux of the third component in the feed stream, is relatively greater in a second portion of the first product stream produced during a second period of the sorbing step than in a first portion of a first product stream produced during the first period of the sorbing step. In an embodiment, a sorptive process can comprise employing (and admitting into at least one contactor) at least one of: at least a portion of a second portion of a first product stream; a second component (such as a N₂ component) recovered from the second portion of a first product stream; and/or a third component (such as a H₂O component) recovered from the second portion of a first product stream; as at least a portion of, a regeneration stream during a regenerating step, a first regeneration stream during a first regenerating step, and/or a second regeneration stream during a second regenerating step. Recovering and employing a second portion of the first product stream comprising a third component (such as a H₂O component) and/or at least a portion of a third component recovered from a second portion of a first product stream for a sorptive process can advantageously reduce an amount of water sourced from an external supply to the sorptive process and/or a sorption separator, which can result in reducing equipment, complexity, capital costs and operating cost, and/or enable operation of a sorptive process in geographical areas where water may be scarce. In one embodiment, a sorbing step, a second period of a sorbing step, producing a second portion of a first product stream, and/or recovery of the second portion of the first product stream, can be completed and terminated when at least one predetermined thresholds or values have been achieved (for example, when a predetermined sorption time has elapsed, when a predetermined temperature of sorption been reached, when a predetermined concentration or flux of at least one of the third component or first component is achieved in a second portion of a first product stream, and/or prior to breakthrough of the first component, such as the CO₂ component, from the contactor) by, for example, terminating the admission of the feed stream into the at least one contactor, and/or moving the contactor or a portion of a contactor away from a sorption zone or the feed stream. Upon completion and/or termination of the sorbing step, a second period of a sorbing step, and/or recovery of a second portion of the first product stream, in one aspect, a subsequent optional third period of the sorbing step and/or a regenerating step (such as a first regenerating step) can follow the sorbing step or second period of a sorbing step.

In an alternative process embodiment, a sorbing step can further comprise a third period of a sorbing step (substantially concurrent with the sorbing step) where a third portion of a first product stream having a first component (such as a CO₂ component) comprising a volume concentration or a flux equal to or greater than, for example, about a volume concentration or a flux of a first component in ambient air, optionally depleted in a third component (such as a H₂O component) relative to a feed stream, can be recovered optionally from at least one contactor. In a process embodiment, a third period of the sorbing step comprises: optionally admitting a feed stream into at least one contactor comprising at least one sorbent, for example, a chemisorbent or an amine doped sorbent; passing the feed stream along the at least one sorbent; optionally sorbing at least a portion of a first component of the feed stream on the at least one sorbent of the at least one contactor; producing a third portion of a first product stream; recovering a third portion of the first product stream from the at least one contactor; optionally further separating and recovering at least one of a first component (such as a CO₂ component) from the third portion of the first product stream; and optionally recovering or exhausting the first product stream. In an alternative embodiment, a sorptive process comprise employing (and admitting into at least one contactor) at least one of: at least a portion of a third portion of the first product stream and/or a first component (such as a CO₂ component) recovered from a third portion of a first product stream as: at least a portion of a regeneration stream during a regenerating step, at least a portion of a first regeneration stream during a first regenerating step, at least a portion of a second regeneration stream during a second regenerating step, and/or a portion of the feed stream. In one embodiment, a sorbing step, a third period of a sorbing step, producing a third portion of a first product stream, and/or recovery of a third portion of the first product stream can be completed and terminated when at least one predetermined thresholds or values have been achieved (for example, when a predetermined sorption time has elapsed, when a predetermined temperature of sorption or a sorbent is achieved, when a predetermined concentration or a flux of a first component is achieved in a third portion of a first product stream) by, for example, terminating the admission of the feed stream into the at least one contactor, and/or moving the contactor or a portion of a contactor away from a sorption zone or the feed stream. Upon completion and/or termination of the sorbing step, third period of a sorbing step, recovery of the third portion of the first product stream, in one aspect, at least one subsequent regenerating step (such as a first regenerating step) can follow the sorbing step or third period of a sorbing step.

In a process embodiment, at least one regenerating step, for example, a first regenerating step can be employed to at least partially regenerate, or desorb at least a portion of a first component (such as an acid gas component, a CO₂ component, a sulfur oxide component, an oxides of nitrogen component, or a heavy metal compound) sorbed on at least one chemisorbent or amine doped sorbent of at least one contactor, and recover a second product stream enriched in the first component relative to the feed stream from the at least one contactor. In one embodiment, at least one regenerating step, such as a first regenerating step, can employ at least one desorptive mechanism including, for example, a temperature swing, a partial pressure swing, a humidity swing, a pressure swing, a vacuum swing, a purge, a displacement purge, and any combinations thereof. In one such aspect, at least one regenerating step such as a first regenerating step can be initiated, for example, upon completion and termination of at least one of a second period of a sorbing step, a third period of a sorbing step, or a sorbing step. In a process embodiment, a regenerating step, for example, a first regenerating step, can comprise employing and admitting a regeneration stream, for example, a first regeneration stream, into at least one contactor having said at least one sorbent for desorbing at least a portion of a first component sorbed on the at least one sorbent of the at least one contactor.

In a process embodiment, at least one regenerating step, for example, a first regenerating step, comprises: optionally admitting a first regeneration stream having, for example, at least a third component (such as a H₂O or a steam component), or a mixture of a first component (for example, an acid gas component or a CO₂ component) and a third component, transferring or generating sufficient energy for regeneration (for example, the stream temperature is above a desorption temperature of a first component on a sorbent), into at least one contactor comprising at least one sorbent, for example, a chemisorbent or an amine doped sorbent; passing the first regeneration stream along the at least one sorbent; desorbing at least a portion of a first component sorbed on the at least one sorbent; producing a second product stream enriched in the first component relative to the feed stream; and recovering a second product stream enriched in the first component relative to the feed stream optionally from at least one contactor. A first regeneration stream can further comprise a ratio of partial pressure to saturation pressure of a third component of, for example, equal to or greater than about 0.01, which advantageously increases the durability of the chemisorbent or amine doped sorbent by reducing the formation of amine oxidation products. Employing a first regeneration stream having a reduced concentration of oxygen, for example, a substantially steam stream, a mixture of substantially a second component and a third component, or a mixture of substantially a first component and a third component, can advantageously increase the durability of a chemisorbent or an amine doped sorbent by reducing oxidation of the sorbent. An embodiment can comprise employing (and admitting into at least one contactor) at least one of: at least a portion of a second portion of a first product stream produced and recovered during a second period of a sorbing step; at least a portion of a second component and/or a third component recovered from a second portion of a first product stream produced and recovered during a second period of a sorbing step; at least a portion of a third portion of the first product stream produced and recovered during a third period of a sorbing step; and/or at least a portion of a first component recovered from a third portion of a first product stream produced and recovered during a third period of a sorbing step, as at least a portion of a regeneration stream during a regenerating step or as at least a portion of a first regeneration stream during a first regenerating step. In one aspect, a first regenerating step and recovery of a second product stream can be completed or terminated when at least one predetermined thresholds, for example, a threshold in relation to elapsed time or duration, a threshold in temperature, and/or a threshold concentration or flux of a selected component or components, is achieved. Upon completion and/or termination of a regenerating step such as a first regenerating step, and/or recovery of the second product stream, in one aspect, a second regenerating step, a cooling step, or a sorbing step can follow the regenerating step or first regenerating step.

Sorptive gas separation processes employing multiple regeneration steps (for example, a first regenerating step and a second regenerating step) relative to sorptive gas separation processes employing a single regenerating step, can advantageously enable a reduction in steam consumption, energy consumption and/or operating cost for desorption of sorbed components and regeneration of sorbents relative to a process employing a single regeneration step. A sorptive gas separation processes employing a first regenerating step and a second regenerating step are known and disclosed in International Published Patent Application WO 2017/165974 A1. The present invention teaches improvements over WO 2017/165974 A1 including, for example, separating and employing a third component (such as a H₂O component) recovered from a second portion of a first product stream for a sorptive process (such as admitting the recovered H₂O component into a first and/or a second regeneration stream during a first and/or second regenerating step or for supplementation of the first and/or a second regeneration stream with recovered H₂O); and employing and admitting a second portion of a first product stream as a second regeneration stream during a second regenerating step which can provide a second regeneration stream having a greater concentration of H₂O.

In a process embodiment, an optional second regenerating step subsequent to a first regenerating step, can be optionally employed to at least partially regenerate or desorb at least a portion of at least one of a first component (for example, an acid gas component or a CO₂ component) and/or a third component (for example, a H₂O component), sorbed on at least one chemisorbent or amine doped sorbent of at least one contactor, and to recover a third product stream enriched in at least one of the first component and/or the third component relative to the feed stream optionally from at least one contactor. In one embodiment, a second regenerating step can employ at least one desorptive mechanism including, for example, a temperature swing, a partial pressure swing, a humidity swing, a pressure swing, a vacuum swing, a purge, a displacement purge, and any combinations thereof. In one such aspect, optional second regenerating step can be initiated, for example, upon completion and termination of a first regenerating step.

In an embodiment, a second regenerating step comprises: optionally admitting a second regeneration stream having, for example, substantially a third component, a second component and a third component, a first component and a third component, or combinations thereof, into at least one contactor comprising at least one sorbent, for example, a chemisorbent or an amine doped sorbent; passing the second regeneration stream along the at least one sorbent; desorbing at least a portion of at least one of a first component and/or a third component sorbed on the at least one sorbent; producing a third product stream enriched in at least one of a first component and/or a third component relative to the feed stream; and recovering a third product stream enriched in at least one of a first component and/or a third component relative to the feed stream optionally from at least one contactor. A first component is, for example, an acid gas component, a CO₂ component, a sulfur oxide component, an oxides of nitrogen component, or a heavy metal compound; a second component is, for example, an inert component such as a N₂ component, and a third component is a H₂O component, a solvent, or a condensable fluid. A second regeneration stream comprise at least one component having a partial pressure less than an equilibrium partial pressure of the at least one component sorbed on the at least one chemisorbent or amine doped sorbent in a contactor. A second regeneration stream can further comprise a ratio of partial pressure to saturation pressure of, for example, equal to or greater than about 0.01, of a third component which advantageously increases the durability of the chemisorbent or amine doped sorbent by reducing the formation of amine oxidation products. Employing a second regeneration stream comprising a reduced volume concentration of oxygen can advantageously increase the durability of the chemisorbent or amine doped sorbent by reducing oxidation. Furthermore, employing a second regeneration stream comprising both a ratio of partial pressure to saturation pressure of a third component of, for example, equal to or greater than about 0.01, and a reduced volume concentration of oxygen, can advantageously increase the durability of the chemisorbent or amine doped sorbent by reducing formation of urea groups and oxidation.

In an embodiment, a second regenerating step comprises: employing (and admitting into at least one contactor comprising at least one sorbent, for example, a chemisorbent or an amine doped sorbent) at least one of: at least a portion of a first portion of a first product stream recovered during a first period of a sorbing step; at least a portion of a second component (for example, an inert component such as a N₂ component) recovered from at least one of a first portion and/or a second portion of a first product stream during a first period and/or a second period of a sorbing step; at least a portion of a second portion of a first product stream recovered during a second period of a sorbing step; at least a portion of a third component (such as a H₂O component) recovered from a second portion of a first product stream during a second period of a sorbing step; at least a portion of a third portion of a first product stream recovered during a third period of a sorbing step; and/or at least a portion of a first component (for example, an acid gas component such as a CO₂ component) recovered from a third portion of a first product stream during a third period of a sorbing step; as at least a portion of a second regeneration stream during a second regenerating step. The second regenerating step, further comprises: desorbing at least a portion of at least one of a first component and/or a third component sorbed on the at least one sorbent; producing a third product stream, and recovering a third product stream enriched in at least one of a first component and/or a third component relative to the feed stream optionally from at least one contactor. Recovering and employing a second portion of the first product stream and/or a third component recovered from a second portion of a first product stream during a second period of a sorbing step for employment as at least a portion of a second regeneration stream during a second regenerating step and/or sorptive process advantageously reduces an amount of water sourced from an external supply to a sorptive process and/or a sorptive separator, which advantageously results in reducing equipment, complexity, capital costs and operating cost. As a second regeneration stream flows within the contactor and contacts the at least one sorbent, the second regeneration stream causes at least a portion of the sorbed components to desorb from the at least one sorbent. In an embodiment, a swing in temperature and/or a difference in partial pressure, concentration, or flux between the second regeneration stream and an equilibrium partial pressure of the sorbed components (for example, a third component and a first component), can cause the sorbed components to desorb. In one such aspect, a portion of the second regeneration stream and/or desorbed components can form and/or produce a third product stream which can be enriched in, for example, the first component and/or third component relative to the feed stream. A third product stream can be recovered optionally from the at least one contactor. In one aspect, a second regenerating step and recovery of the third product stream can be completed or terminated when at least one predetermined thresholds, for example, a threshold in relation to elapsed time or duration, a threshold in temperature, and/or a threshold concentration or flux of a selected component or components, is reached. Upon completion and/or termination of second regenerating step and/or recovery of a third product stream, in one aspect, a cooling step, or a sorbing step can subsequently follow the second regenerating step.

In an alternative embodiment, a sorptive process employing a plurality of sorptive separators comprise: recovering from a first sorptive separator at least a portion of and at least one of a first portion of a first product stream, a second portion of a first product stream, and/or a third portion of a first product stream; admitting and employing at least one of the first portion of the first product stream, the second portion of the first product stream, and/or the third portion of the first product stream, into a second sorptive separator as at least a portion of at least one of a regeneration stream, a plurality of regeneration streams, and/or a feed stream. A sorptive process employing a plurality of sorptive separators may comprise at least one sorptive separator further comprising at least one chemisorbent. A sorptive process employing a plurality of sorptive separators may comprise at least one sorptive separator further comprising at least one chemisorbent, and at least one sorptive separator further comprising a sorbent other than a chemisorbent.

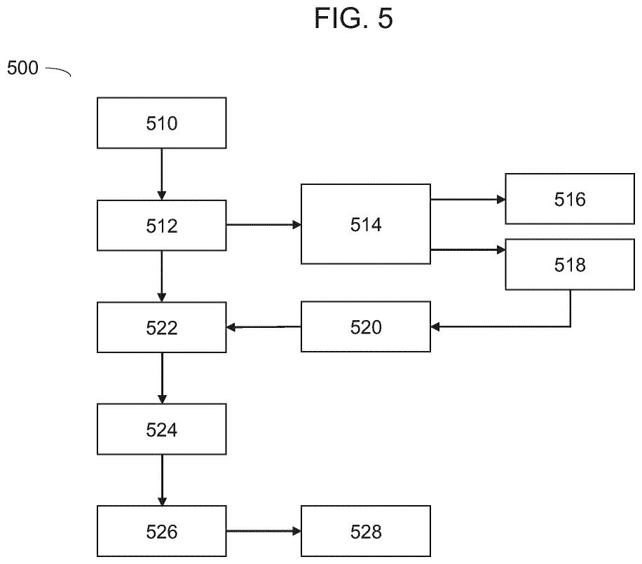

With reference to FIG. 5, in an embodiment, a sorptive process 500 for separating components in a feed stream having at least a first component, a second component, and a third component, comprising: a passing step 510, further comprising passing the feed stream along a sorbent; a sorbing step 512, further comprising sorbing the first component in and/or on the sorbent; a producing step 514, further comprising producing a first product stream containing the second component and the third component; a recovering step 516, further comprising recovering the second component from the first product stream during a first time period; a recovering step 518, further comprising recovering the third component from the first product stream at a second time period; a recirculating step 520, further comprising recirculating or employing at least a portion of the third component recovered from the first product stream as at least a part of a regeneration stream (for example, a first regeneration stream); a passing step 522, further comprising passing the first regeneration stream along the sorbent, a desorbing step 524, further comprising desorbing the first component from the sorbent, a producing step 526, further comprising producing a second product stream having the first component desorbed from the sorbent, and a recovering step 528, further comprising recovering the first component from the second product stream. In an embodiment, the third component recovered from the first product stream or the third component recovered from the first product stream during a second time period, can be recirculated and employed as part of the first regeneration stream.

In a process embodiment, a sorptive process can comprise at least a sorbing step (including, for example, a first period of a sorbing step, a second period of a sorbing step, and optionally a third period of a sorbing step), a regenerating step such as a first regenerating step, and optionally a second regenerating step, where the steps can be repeated sequentially and optionally over numerous cycles, for example, about 3 cycles, about 5 cycles, about 10 cycles, or about 50 cycles.

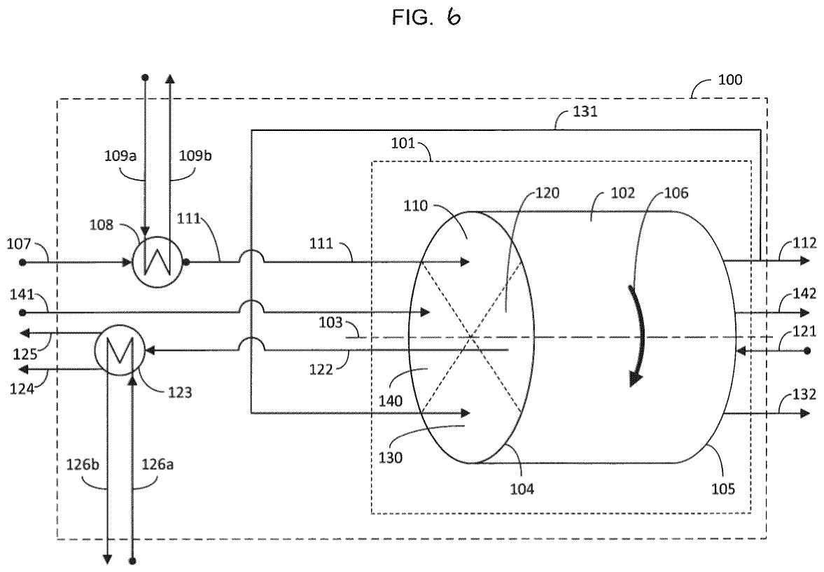

FIG. 6 is a simplified schematic diagram illustrating an exemplary sorptive gas separation system or sorptive system 100 comprising an optional heat exchanger or direct contact cooler 108, a sorptive gas separator or sorptive separator 101, comprising a moving contactor 102, and a condenser or specifically a condensing heat exchanger 123. The exemplary sorptive gas separator 100 is configured having a single contactor 102 cycling or rotating around an axis through four stationary zones, for example, an sorption zone 110, a first regeneration zone 120, an optional second regeneration zone 130, and a conditioning zone 140, suitable for application according to an exemplary embodiment of the sorptive processes described above. The sorptive gas separator 101 is fluidly connected to receive at least a portion of the feed stream for the sorptive separation system, as a feed stream. In an exemplary application, the embodiment sorptive gas separation system may be employed for sorptive gas separation of at least a first component (such as, for example, an acid gas component, a carbon dioxide component, a sulfur oxide component, an oxides of nitrogen component, or a heavy metal compound), from a feed stream, (for example, a flue gas stream or a combustion gas stream produced by a fuel combustor, a process stream or an air stream and/or any combination thereof). The combustion gas stream also comprises, a second component, (for example, an inert component such as or N₂ component), and a third component, (for example, H₂O, a solvent, or a condensable fluid).

An exemplary sorptive gas separation system or a sorptive system 100 comprises an optional heat transfer device, for example, a direct contact cooler or DCC 108, a condensing heat exchanger 123, and an exemplary sorptive gas separator or sorptive separator 101, comprising an enclosure (not shown in FIG. 6) and a contactor 102. The enclosure (not shown in FIG. 6) may assist in defining a plurality of stationary zones (shown between dashed lines in FIG. 6), for example, an sorption zone 110, a first regeneration zone 120, a second regeneration zone 130, and a conditioning zone 140, where the zones are substantially fluidly separate to each other within the enclosure (not shown in FIG. 6) and contactor 102. Contactor 102 may comprise: a plurality of substantially parallel walls which may define a plurality of substantially parallel fluid flow passages (not shown in FIG. 6) oriented in an axial direction parallel to a longitudinal axis or first axis 103, between a first end 104 and a second end 105 which are axially opposed; at least one chemisorbent or amine doped sorbent (not shown in FIG. 6) including but not limited to, an amine grafted silica, amine impregnated mesoporous silica, an alkylated amine impregnated porous sorbent, an amine functionalized porous nano-polymers, an amine functionalized organic framework, an amine functionalized metal organic framework, an amine tethered porous polymer, and any combination thereof, in and/or on the walls of contactor 102; optionally a plurality of continuous electrically and/or thermally conductive filaments (not shown in FIG. 6) oriented substantially parallel (and optionally substantially perpendicular) to first axis 103, which are optionally in direct contact with at least one chemisorbent or amine doped sorbent (not shown in FIG. 6) in or on the walls (not shown in FIG. 6) of contactor 102. Contactor 102 may be powered by any suitable device (not shown in FIG. 6), for example, an electric motor (not shown in FIG. 6), which cycles or rotates contactor 102 around first axis 103, in a direction shown by an arrow 106, substantially continuously or intermittently and through stationary zones, for example, sorption zone 110, first regeneration zone 120, second regeneration zone 130, and conditioning zone 140.

A multi-component fluid stream source or feed source, for example, a combustor, a process stream source, and/or an ambient air source, (not shown in FIG. 6) may be fluidly connected to admit a multi-component fluid mixture, for example, a combustion gas stream, a process stream, an ambient air stream and/or any combination thereof, as a feed stream 107, into sorptive system 100, an optional heat transfer device, for example, a direct contact cooler or a DCC 108, and sorptive separator 101. A coolant source (not shown in FIG. 6) may be fluidly connected to admit a coolant stream 109a into DCC 108 and optionally to recover a coolant stream 109b from DCC 108. At least a portion of feed stream 107 may be admitted in DCC 108, to reduce the temperature of feed stream 107, such as to equal to or less than a first temperature threshold, for example, about 50° C., or particularly about 40° C., or more particularly about 30° C., for producing a feed stream 111. Alternatively, DCC 108 may comprise any suitable heat exchange device including, for example, a gas-to-gas heat exchanger, or a gas-to-liquid heat exchanger.

DCC 108 may be fluidly connected to admit feed stream 111 into sorptive separator 101, sorption zone 110 and a portion of contactor 102 within sorption zone 110, to flow in a direction substantially from first end 104 to second end 105 of contactor 102. As feed stream 111 contacts the at least one chemisorbent or amine doped sorbent (not shown in FIG. 6) within sorption zone 110, at least a portion of a first component, for example, CO₂, may be sorbed on the at least one chemisorbent or amine doped sorbent (not shown in FIG. 6), separating the first component from feed stream 111. The non-sorbed components, for example, second component or N₂, may produce a first product stream 112, which may desirably be depleted in the first component relative to feed stream 111, and may be recovered from second end 105 of a portion of contactor 102 within sorption zone 110, sorption zone 110, sorptive separator 101, and sorptive system 100. Sorption zone 110, sorptive separator 101, and sorptive system 100 may be fluidly connected to direct at least a portion of first product stream 112 to, for example, a stack for dispersion and release into the atmosphere, to another gas separation process, or to an industrial process (all not shown in FIG. 6).

A first regeneration stream source or a low exergy source, for example, a low pressure stage or a very low pressure stage of a multistage steam turbine, a very low pressure steam turbine, a low pressure boiler or very low pressure boiler (all not shown in FIG. 6), may be fluidly connected to admit a first regeneration stream 121, comprising, for example, a steam stream low in exergy, at a temperature equal to or greater than about a condensation temperature of first regeneration stream 121, into sorptive system 100, sorptive separator 101, first regeneration zone 120, and a portion of contactor 102 within first regeneration zone 120, to flow in a direction substantially from second end 105 to first end 104 of contactor 102, or in a substantially counter-current flow direction in relation to the direction of flow of feed stream 111. As first regeneration 121 contacts the at least one chemisorbent or amine doped sorbent (not shown in FIG. 6) within first regeneration zone 120, of sorptive separator 101, a component, (for example, the third component or H₂O), may sorb on the at least one chemisorbent or amine doped sorbent (not shown in FIG. 6), displacing components sorbed on and/or in the at least one sorbent and generating a heat of sorption which along with the heat energy in first regeneration stream 121 may assist in desorbing at least a portion of at least the first component sorbed on the at least one chemisorbent or amine doped sorbent (not shown in FIG. 6) in contactor 102 within first regeneration zone 120 and sorptive separator 101. A portion of first regeneration stream 121 and/or desorbed components, for example, first component, may produce a second product stream 122 which may be enriched in the first component relative to the feed stream 111 and may be recovered from first end 104 of a portion of contactor 102 within first regeneration zone 120, first regeneration zone 120 and sorptive separator 101. Optionally, a first portion of second product stream 122 recovered from first end 104 of a portion of contactor 102 within first regeneration zone 120 and first regeneration zone 120 may be enriched with the first component relative to feed stream 111 and have a low partial pressure of the third component or a low relative humidity, while a second or subsequent portion of the second product stream 121 recovered from first end 104 of a portion of contactor 102 within first regeneration zone 120 and first regeneration zone 120 may be enriched in at least one component of the first regeneration stream, for example, third component, relative to feed stream 111. Optionally, sorptive separator 101 may be fluidly connected to optionally at least periodically recover a first portion of second product stream 122 from first regeneration zone 120, for example, from a first end 104 of a portion of contactor 102 within first regeneration zone 120 and optionally sorptive separator 101, and admit the first of portion of second product stream 122 into optionally sorptive separator 101 and second regeneration zone 130, for example, into a second end 105 of a portion of contactor 102 within second regeneration zone 130, as at least a portion of a second regeneration stream (not shown in FIG. 6) in a second regeneration step. The second portion of second product stream 122 may be recovered from first regeneration zone 120, for example, from a first end 104 of a portion of contactor 102 within first regeneration zone 120, and sorptive separator 101 before admitting into a product circuit (not shown in FIG. 6) of condensing heat exchanger 123.

A condenser coolant source (not shown in FIG. 6) may be fluidly connected to admit a coolant stream 126a into a cooling circuit or a cold circuit (both not shown in FIG. 6) of condensing heat exchanger 123 and optionally recover a coolant stream 126b from the cooling circuit (not shown in FIG. 6) of condensing heat exchanger 123, to transfer and remove heat from a product circuit or hot circuit (both not shown in FIG. 6) of condensing heat exchanger 123. The product circuit (not shown in FIG. 6) of condensing heat exchanger 123 may be fluidly connected to sorptive separator 101, first regeneration zone 120, a portion of contactor 102 within first regeneration zone 120, optionally the second regeneration zone 130 and a portion of contactor 102 within second regeneration zone 130, optionally a compressor (not shown in FIG. 6), an end user for a purified or compressed second product stream (not shown in FIG. 6) and optionally a condensate tank, source or end use (all not shown in FIG. 6). At least a portion of second product stream 122 may be recovered from first regeneration zone 120, for example, from a first end 104 of a portion of contactor 102 within first regeneration zone 120, and sorptive separator 101, and admitted in a product circuit (not shown in FIG. 6) of condensing heat exchanger 123, such as to reduce the temperature of and/or remove heat from second product stream 122, causing condensable components, for example, third component or H₂O, to at least partially condense and separate from second product stream 122, producing a condensate stream 124 and a purified second product stream 125. As the condensable component condenses, a reduction in pressure or a vacuum may be induced in the product circuit (not shown in FIG. 6) of condensing heat exchanger 123, and fluidly connected passages and/or components, for example, first regeneration zone 120 of sorptive separator 101, optionally second regeneration zone 130 of sorptive separator 101, and at least a portion of contactor 102 within first regeneration zone 120 and optionally second regeneration zone 130. The reduction in pressure or vacuum may advantageously enable vacuum assisted desorption of components, for example, first component and/or third component, sorbed on the at least one chemisorbent or amine doped sorbent (not shown in FIG. 6) in a portion of contactor 102 within first regeneration zone 120 and/or optionally second regeneration zone 130. Product circuit (not shown in FIG. 6) of condensing heat exchanger 123 may be fluidly connected to direct and admit condensate stream 124 into, for example, an optional pump and a condensate tank, source or end use (all not shown in FIG. 6), and purified second product stream 125 into a purified or compressed second product stream end use or user (all not shown in FIG. 6) via an optional one or more pumps (such as, for example, an ejector, a vacuum pump, or a single stage or multistage compressor operating optionally at sub-ambient inlet pressure), an optional one or more valves (such as for example, a check valve or a throttling valve), optional at least one additional condensing heat exchangers and/or condenser stages, and optional compressor for increasing the pressure of the purified second product stream. Optionally, condensing heat exchanger 123 may be fluidly connected to direct and admit at least a portion of purified second product stream 125 into an optional first heater or optional auxiliary heat exchanger (both not shown in FIG. 6) and into sorptive separator 101, second regeneration zone 130 and a portion of contactor 102 within second regeneration zone 130 as at least a portion of a second regeneration stream (not shown in FIG. 6).

In an embodiment, second end 105 of a portion of contactor 102 within sorption zone 110 (and part of sorptive separator 101), may be fluidly connected and controlled to at least periodically recover and admit at least a portion of first product stream 112 (for example, a portion of first product stream 112 enriched in the third component and depleted in the first component relative to feed stream 111 during a second period of a sorbing step, and/or a portion of first product stream 112 prior to breakthrough of the first component from second end 105 of contactor 102, while having a partial pressure to saturation pressure of a third component equal to or greater than, for example, about 0.010), as at least a portion of a second regeneration stream 131 into sorptive separator 101, second regeneration zone 130 and a portion of contactor 102 within second regeneration zone 130, optionally to flow in a direction substantially from first end 104 to second end 105 of contactor 102, or in a substantially co-current flow direction in relation to the direction of flow of feed stream 111.

A second regeneration stream 131 may be admitted into sorptive separator 101, second regeneration zone 130 and a portion of contactor 102 within second regeneration zone 130, to flow in a direction substantially from first end 104 to second end 105 of contactor 102, or in a substantially co-current flow direction in relation to the direction of flow of feed stream 111. Second regeneration stream 131 may comprise, for example, first component, second component and/or third component, where at least one component, for example, a third component, comprises a partial pressure, or concentration less than an equilibrium partial pressure of the at least one component, for example, a third component, sorbed on the at least one chemisorbent or amine doped sorbent in a portion of contactor 102 within second regeneration zone 130, while having a partial pressure to saturation pressure of a third component equal to or greater than, for example, about 0.010. Second regeneration stream 131 may also comprise a temperature equal to or greater than a third temperature threshold, for example, about the condensation temperature of second regeneration stream 131, about 80° C., about 70° C., or about 60° C. As second regeneration stream 131 flows in a portion of contactor 102 within second regeneration zone 130, a partial pressure swing and/or a humidity swing may cause at least a portion of the at least one component, for example, third component, sorbed on the at least one chemisorbent or amine doped sorbent (not shown in FIG. 6) within second regeneration zone 130 to at least partially desorb. A portion of second regeneration stream 131 and/or desorbed components, for example, third component and first component, may produce a third product stream 132 which may be enriched in at least one component, for example, the third and optionally the first component, relative to feed stream 111. Third product stream 132 may be recovered from second end 105 of a portion of contactor 102 within second regeneration zone 130, second regeneration zone 130, sorptive separator 101, and sorptive system 100. Optionally, second regeneration zone 130, and sorptive separator 101 may be fluidly connected to direct and admit at least a portion of third product stream 132 into sorption zone 110 of sorptive separator 101 as a portion of a feed stream 107 or feed stream 111, or into the multicomponent fluid stream source or feed source (not shown in FIG. 6), for example, a combustor (not shown in FIG. 5) as a portion of an oxidant stream employed for combustion and production of the combustion gas stream.

At least a portion of contactor 102, second regeneration zone 130, and sorptive separator 101 may be fluidly connected to an optional compressor (not shown in FIG. 6) employed to increase the pressure of purified second product stream 125, for example, an interstage of a multistage compressor (not shown in FIG. 6) or downstream of the optional compressor (not shown in FIG. 6), to recover and admit a fluid stream enriched in the first component relative to feed stream 111 (for example, at least a portion of a compressed second product stream), for employment as at least a portion of a second regeneration stream (not shown in FIG. 6).

A coolant source, for example, ambient air, may be fluidly connected to a fan or a blower (not shown in FIG. 6), to admit a conditioning stream 141, for example, an air stream, at a temperature equal to or less than a first temperature threshold (such as, for example, about 50° C., or in particular about 40° C., or more particularly about 30° C.), into sorptive system 100, sorptive separator 101, conditioning zone 140, and a portion of contactor 102 within conditioning zone 140, to flow in a direction substantially from first end 104 to second end 105 of contactor 102, or in a substantially co-current flow direction in relation to the direction of flow of the feed stream or combustion gas stream 111. As conditioning stream 141 flows in a portion of contactor 102 within conditioning zone 140, conditioning stream 141 may increase or reduce the temperature of the at least one chemisorbent or amine doped sorbent in conditioning zone 140 and/or purge components from the at least one chemisorbent or amine doped sorbent, a portion of contactor 102 in conditioning zone 140, and conditioning zone 140. Conditioning stream 141 and/or desorbed or residual components may produce a fourth product stream 142 which may be recovered from second end 105 of a portion of contactor 102 within conditioning zone 140, conditioning zone 140, sorptive separator 101, and sorptive system 100. Conditioning zone 140, sorptive separator 101, and sorptive system 100 may be fluidly connected to direct and admit fourth product stream 142 to, for example, into the feed source (not shown in FIG. 6), for example, a combustor (not shown in FIG. 6) as a portion of an oxidant stream for the combustor, or a stack (not shown in FIG. 6) for dispersion and release into the atmosphere.

What is claimed is:

1. A sorptive gas separation process for separating components of a feed stream containing at least a first component, a second component and a third component, said sorptive gas separation process comprising:
passing said feed stream along at least one sorbent;
sorbing said first component of said feed stream onto said sorbent;
producing a first portion of a first product stream;
producing a second portion of said first product stream;
passing a first regeneration stream along said sorbent for desorbing said first component from said sorbent;
producing a second product stream containing at least said first component; and
further comprising at least one of:
recovering at least one of: a portion of said first portion, said second component, a portion of said second portion, said second component, or said third component, of said first product stream.

2. The sorptive gas separation process of claim 1, further comprising at least one of: employing said first portion and/or said second component of said first product stream as at least a portion of said feed stream and/or said first regeneration stream; and employing said second portion, said second component, and/or said third component, of said first product stream as at least a portion of said first regeneration stream.

3. The sorptive gas separation process of claim 1, further comprising passing a second regeneration stream along said sorbent for desorbing said first component and/or said third component from said sorbent; and at least one of: recovering at least a portion of said first portion and/or said second component of said first product stream, and employing said first portion and/or said second component of said first product stream as at least a portion of said second regeneration stream; and recovering at least a portion of said second portion, said second component, and/or said third component, of said first product stream, and employing said second portion, said second component, and/or said third component, of said first product stream as at least a portion of said second regeneration stream.

4. The sorptive gas separation process of claim 1, 2 or 3, further comprising producing a third portion of said first product stream, recovering at least a portion of said third portion and/or said first component of said first product stream, and employing said at least a portion of said third portion and/or said first component of said first product stream as at least a portion of said first regeneration stream, at least a portion of said second regeneration stream, and/or a portion of said feed stream.

5. A sorptive gas separation process for separating components of a feed stream containing at least a first component, a second component and a third component, said sorptive gas separation process comprising:
passing said feed stream along at least one sorbent;
sorbing said first component of said feed stream onto said sorbent;
producing a first product stream containing at least said second component and said third component;
passing a first regeneration stream along said sorbent for desorbing said first component from said sorbent; and
producing a second product stream containing at least said first component,
wherein said third component of said first product stream is recovered from said first product stream.

6. The sorptive gas separation process of claim 5, wherein when said first component is passed along said at least one sorbent, said first component is sorbed thereon and assists in desorbing any third component sorbed onto said sorbent, and said desorbed third component forms a portion of said first product stream.

7. The sorptive gas separation process of claim 5, wherein when said third component is passed along said at least one sorbent, said third component is sorbed thereon and assists in desorbing any first component sorbed onto said sorbent, and said desorbed first component forms a portion of said second product stream.

8. The sorptive gas separation process of claim 5, wherein passing said first regeneration stream further comprises passing said first regeneration stream comprising said third component.

9. The sorptive gas separation process of claim 8, wherein passing said first regeneration stream further comprises passing said first regeneration stream at a temperature equal to or greater than a condensation temperature of said first regeneration stream.

10. The sorptive gas separation process of claim 8 or 9, wherein passing said first regeneration stream further comprises passing said first regeneration stream additionally comprising said first component.

11. The sorptive gas separation process of claim 10, further comprising recovering a first component of said first product stream, and recirculating said first component of said first product stream as at least a portion of said first regeneration stream.

12. The sorptive gas separation process of any one of claim 5, 8, or 9, further comprising recirculating said third component of said first product stream as at least a portion of said first regeneration stream.

13. The sorptive gas separation process of claim 5, further comprising passing a second regeneration stream along said sorbent for desorbing at least one of said first component and said third component from said sorbent, and producing a third product stream.

14. The sorptive gas separation process of claim 13, further comprising recovering a first portion of said first product stream, and recirculating said first portion of said first product stream as at least a portion of said second regeneration stream.

15. The sorptive gas separation process of claim 13 or 14, further comprising recovering a second portion of said first product stream, and recirculating said second portion of said first product stream as at least a portion of said second regeneration stream.

16. The sorptive gas separation process of claim 13, further comprising recovering said second component from said first product stream, and recirculating said second component from said first product stream as at least a portion of said second regeneration stream.

17. The sorptive gas separation process of claim 13 or 14, further comprising recirculating said third component of said first product stream as at least a portion of said second regeneration stream.

18. The sorptive gas separation process of claim 5 or 16, further comprising recovering said second component from said first product stream during a first period.

19. The sorptive gas separation process of claim 5, 12, or 17, further comprising recovering said third component of said first product stream during a second period.

20. The sorptive gas separation process of claim 11, further comprising recovering said first component of said first product stream during a third period.

21. The sorptive gas separation process of any one of claim 5, 6, 7 or 13, wherein said at least one sorbent is a chemisorbent, an amine doped adsorbent, an amine grafted silica, amine impregnated mesoporous silica, an alkylated amine impregnated porous adsorbent, amine functionalized porous nano-polymers, amine functionalized organic frameworks, amine functionalized metal organic frameworks, amine tethered porous polymers, or any combination thereof.

22. The sorptive gas separation process of any one of claim 5, 6, 7, 10, 11, 13, or 20, wherein said first component is an acid gas or carbon dioxide.

23. The sorptive gas separation process of any one of claim 5, 16, or 18, wherein said second component is an inert component or nitrogen.

24. The sorptive gas separation process of any one of claim 5, 6, 7, 8, 12, 13, 17, or 19, wherein said third component is water, a solvent or a condensable fluid.

25. A sorptive gas separation process for separating components of a feed stream containing at least a first component, a second component, and a third component, said sorptive gas separation process comprising:
passing said feed stream along at least one sorbent;
sorbing said first component onto said at least one sorbent;
producing a first product stream containing at least said second component and said third component;
passing a first regeneration stream along said at least one sorbent;
desorbing said first component from said at least one sorbent; and
recovering said desorbed first component,
wherein a ratio of a flux of said third component in said first product stream to a flux of said third component in said feed stream is relatively greater during a second period than at a first period.

26. The sorptive gas separation process of claim 25, further comprising recovering said third component of said first product stream during said second period.

27. The sorptive gas process of claim 26, further comprising recirculating at least a portion of said recovered third component for employment as at least a part of said first regeneration stream.

28. The sorptive gas separation process of claim 25, further comprising recovering said second component from said first product stream during said first period, wherein a ratio of a flux of said second component is said first product stream to a flux of said second component in said feed stream is relatively greater during said first period than at said second period.

29. The sorptive gas separation process of claim 25, further comprising passing a second regeneration stream for desorbing at least one of said first component and said third component from said at least one sorbent.

30. The sorptive gas separation process of claim 29, further comprising recirculating at least a portion of said recovered second component for employment as at least a portion of said second regeneration stream.

31. The sorptive gas separation process of any one of claims 25 to 30, wherein said at least one sorbent is a chemisorbent, an amine doped adsorbent, an amine grafted silica, amine impregnated mesoporous silica, an alkylated amine impregnated porous adsorbent, amine functionalized porous nano-polymers, amine functionalized organic frameworks, amine functionalized metal organic frameworks, amine tethered porous polymers, or any combination thereof.
